(19) United States
(12) Patent Application Publication
(10) Pub. No.: US 2006/0101045 A1
(43) Pub. Date: May 11, 2006

(54) Methods and apparatus for interval query indexing

(75) Inventors: Shyh-Kwei Chen, Chappaqua, NY (US); Kun-Lung Wu, Yorktown Heights, NY (US); Philip Shi-Lung Yu, Chappaqua, NY (US)

Correspondence Address: Ryan, Mason & Lewis, LLP, 90 Forest Avenue, Locust Valley, NY, 11560, US

(73) Assignee: International Business Machines Corporation, Armonk, NY (US)

(21) Appl. No.: 10/982,570

(22) Filed: Nov. 5, 2004

(51) Int. Cl. G06F 17/00; G06F 7/00

(52) U.S. Cl. 707/101

(57) ABSTRACT

Interval query indexing techniques for use in accordance with data stream processing systems are disclosed. For example, in an illustrative aspect of the invention, a technique for use in processing a data stream comprises the following steps/operations. First, an attribute range of query intervals associated with the data stream is partitioned into one or more segments. Then, a set of virtual intervals is defined for each of the one or more segments. A query interval index is then built using the set of virtual intervals. The query interval index may be built by decomposing each query interval into one or more of the virtual intervals, and associating a query identifier with the decomposed virtual intervals.

This invention was made with Government support under Contract Number H98230-04-3-0001 awarded by the Distillery Phase II Program. The U.S. Government has certain rights to this invention as provided for by the terms of the Contract.

### CROSS REFERENCE TO RELATED APPLICATION(S)

This invention is related to the U.S. patent application identified by attorney docket no. YOR920040408US1 and entitled “Methods and Apparatus for Performing Structural Joins for Answering Containment Queries,” filed concurrently herewith.

### FIELD OF THE INVENTION

The present invention generally relates to the processing of data streams and, more particularly, to interval query indexing techniques for use in processing data streams.

### BACKGROUND OF INVENTION

Various data stream applications have been recently recognized. Examples include financial applications, network monitoring, security, telecommunications data management, web applications, sensor networks and other applications where data is best modeled as transient data streams. In a data stream model, individual data items may be relational tuples, e.g., network measurements, call records, meta data records, web page visits, sensor readings, and so on. These data records arrive in various streams continually, rapidly, and maybe unpredictably.

In order to monitor a data stream and take proper actions, if needed, a large number of queries and filtering conditions can be created and evaluated continually against the data stream. Because these monitoring queries are evaluated repeatedly and continually against the incoming data stream, they are called continual queries. They are in contrast to regular queries that are usually evaluated only once.

For example, in a financial stream application, various continual range queries can be created to monitor the prices of different stocks, bonds or interest rates. In a sensor network stream application, continual range queries can also be created to monitor the temperatures, flows of traffic, and other readings. These continual queries or filtering conditions can be complex, involving more than one attribute. Many of these continual queries and conditions may involve range operators, such as “<” and/or “>”.

Interval queries are queries with interval predicates, such as “100.50<stock price<101.00”. They are generally more difficult to process against data streams. Sequential processing is clearly not scalable if there are many continual interval queries. This is particularly true when the stream arrives too fast for the processing to be done. When a data record is streamed in, it is preferable that only relevant queries or conditions are evaluated against it.

There are several existing approaches in the area of interval indexing. However, they were not designed for data stream processing. Hence, they are mostly not effective for processing of continual interval queries against data streams, especially if the streams are rapid.

Segment trees and interval trees (see, e.g., H. Samet, “Design and Analysis of Spatial Data Structure,” Addison-Wesley, 1990) generally work well in a static environment, but are not adequate when it is necessary to dynamically add or delete intervals. Originally designed to handle spatial objects, such as rectangles, R-trees (see, e.g., A. Guttman, “R-trees: A Dynamic Index Structure for Spatial Searching,” Proceedings of the ACM SIGMOD, 1984) can be used to index intervals. However, when there is heavy overlapping among the query intervals, the search time can quickly degenerate. Furthermore, R-trees are mostly disk-based, which is less preferable for stream processing especially if data arrives at a rapid rate.

IBS-trees (see, e.g., E. Hanson, et al., “A Predicate Matching Algorithm for Database Rule Systems,” Proceedings of ACM SIGMOD, 1990) and IS-lists (see, e.g., E. Hanson, et al., “Selection Predicate Indexing for Active Databases Using Interval Skip Lists,” Information Systems, 21(3):269-298, 1996) were designed for interval indexing. As with most other dynamic search trees, the search time is O(log(n)) and storage cost is O(n log(n)), where n is the total number of query intervals. However, in order to achieve the O(log(n)) search time, a complex “adjustment” of the index structure is needed after an insertion or deletion. The adjustment is needed to re-balance the index structure. The adjustment of index increases the insertion/deletion time complexity. More importantly, the adjustment makes it difficult to reliably implement the algorithms in practice.

Hence, a need is recognized for an effective interval query indexing method for data stream processing.

### SUMMARY OF THE INVENTION

The present invention provides interval query indexing techniques for use in accordance with data stream processing systems.

For example, in an illustrative aspect of the invention, a technique for use in processing a data stream comprises the following steps/operations. First, an attribute range of query intervals associated with the data stream is partitioned into one or more segments. Then, a set of virtual intervals is defined for each of the one or more segments. A query interval index is then built using the set of virtual intervals.

The query interval index may be built by decomposing each query interval into one or more of the virtual intervals, and associating a query identifier with the decomposed virtual intervals.

The step/operation of defining a set of virtual intervals for each of the one or more segments may further comprise defining a virtual interval which completely covers the segment and labeling the virtual interval with a first local identifier, partitioning the segment into two equal-length virtual intervals and respectively labeling the two equal-length virtual intervals from left to right with second and third local identifiers, partitioning the segment into four equal-length virtual intervals and respectively labeling the four equal-length virtual intervals from left to right with fourth, fifth, sixth and seventh local identifiers, and continuing the partitioning step until each virtual interval has a length of one.

The technique may further comprise the step/operation of searching the query interval index with a data value. This search step may further comprise finding the smallest-sized virtual interval containing the data value, finding other virtual intervals containing the smallest-sized virtual interval, and obtaining query identifiers associated with the found virtual intervals. The virtual intervals for each segment may comprise a set of containment-encoded intervals (CEI), each CEI having a local identifier (ID) and a global ID. A CEI with a local ID of m may contain two half-sized CEIs with local IDs of 2m and 2m+1. Further, the step/operation of finding other virtual intervals containing the smallest-sized virtual interval may further comprise the steps of finding the global ID and local ID of the smallest-sized CEI, and repeatedly dividing the local ID by two to find the local ID of other CEIs that contain the smallest-sized CEI.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating a data stream processing system, according to one embodiment of the present invention;

FIG. 2 is a diagram illustrating a problem of matching a data item against a set of intervals;

FIG. 3 is a diagram illustrating a definition of containment-encoded intervals, according to one embodiment of the present invention;

FIG. 4 is a diagram illustrating a perfect binary tree, according to one embodiment of the present invention;

FIG. 5 is a diagram illustrating a methodology for building an interval query index, according to one embodiment of the present invention;

FIG. 6 is a diagram illustrating a methodology for searching an interval query index, according to one embodiment of the present invention;

FIG. 7 is a diagram illustrating insertion and search operations with a containment-encoded interval indexing methodology, according to an embodiment of the invention; and

FIG. 8 is a diagram illustrating a computer system suitable for implementing a data stream processing system, according to one embodiment of the present invention.

### DETAILED DESCRIPTION OF PREFERRED EMBODIMENTS

It is to be understood that while the present invention may be described below in the context of exemplary data stream applications, the invention is not so limited. Rather, the invention is more generally applicable to any data stream application in which it would be desirable to provide effective interval query indexing techniques.

In a U.S. patent application identified as attorney docket no. YOR920030265US1 and entitled “System and Method for Indexing Queries, Rules and Subscriptions,” filed on Sep. 29, 2003 and assigned Ser. No. 10/673,651, the disclosure of which is incorporated by reference herein, a method to index interval queries is disclosed. A set of virtual construct intervals (VCIs) is predefined for each integer point. Interval queries are first decomposed into one or more of the predefined VCIs. The interval identifier (ID) is then stored in the ID lists associated with the decomposed VCIs. Due to the fact that a set of VCIs is defined for each integer point, the number of VCI can be potentially large. The large number of pre-defined VCIs not only increases the index storage overhead but also slows the search time, making VCI-based query indexing not suitable for fast data stream processing.

To provide effective interval query indexing for data stream processing, the invention provides a containment-encoded interval (CEI) indexing approach for interval query indexing for data stream processing. In one embodiment, the entire attribute range is first partitioned into one and more segment of size L=2^{k}. A set of containment-encoded virtual intervals is predefined for each segment. These virtual intervals are labeled with proper IDs such that their IDs are encoded with containment relationship among them. Namely, from the IDs of two CEIs, their containment relationship can be easily deduced. Hence, the indexing scheme using CEIs is referred to as containment-encoded interval indexing. Note that these CEIs are virtual and remain virtual until they are used for the decomposition of queries. Then, they become activated.

The CEI index is simple and fast to construct. The search results of the CEI index are indirectly pre-computed and stored in the index. Hence, a search operation can be efficiently carried out. Because of the containment encoding, both the construction of the CEI index and the search operation involve only simple operations, such as additions, subtractions and logical shift operations. There is no need for complex floating-point multiplication or division operations. Hence, it is efficient to perform continual interval queries against data streams using a containment-encoded interval indexing approach according to the present invention.

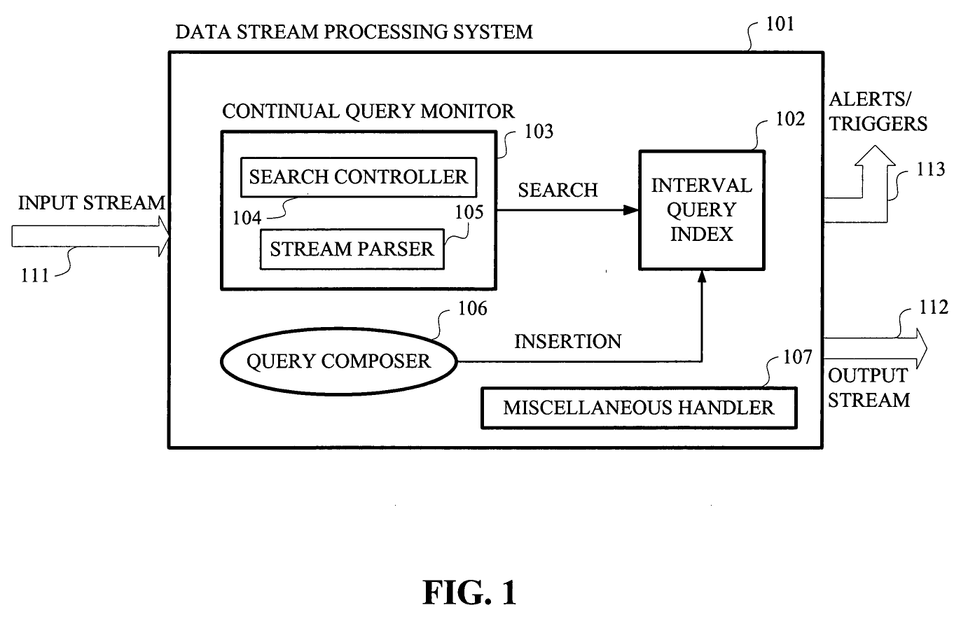

FIG. 1 shows a system block diagram of data stream processing system 101 that employs a containment-encoded query index, according to an embodiment of the present invention. It is to be appreciated that, in one embodiment, data stream processing system 101 processes data items contained in an input data stream 111. Data stream processing system 101 may generate alerts or triggers 113 for other actions after processing data items contained in input data stream 111. Data stream processing system 101 may also generate output data stream 112.

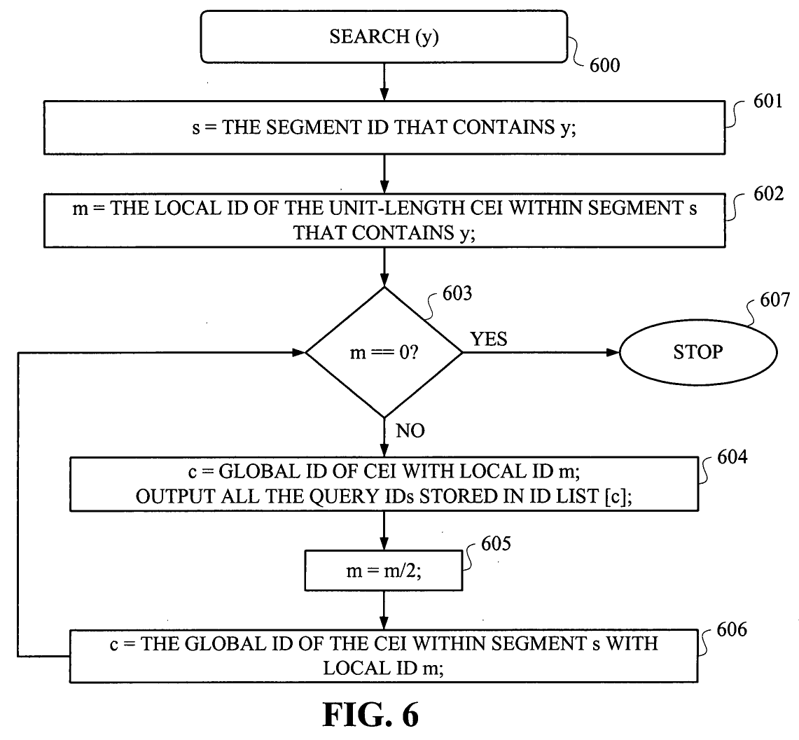

As shown, data stream processing system 101 comprises continual query monitor 103, which continually matches a data item in the input data stream against a plurality of continual interval queries. Continual query monitor 103 comprises stream controller 104 and stream parser 105. Stream parser 105 parses the data contained in the input stream and extracts specific data values, which are then used by search controller 104 to issue search operations (to be further described below in the context of FIG. 6) on interval query index 102. If matched queries are found from a search operation, alerts or triggers 113 may be issued.

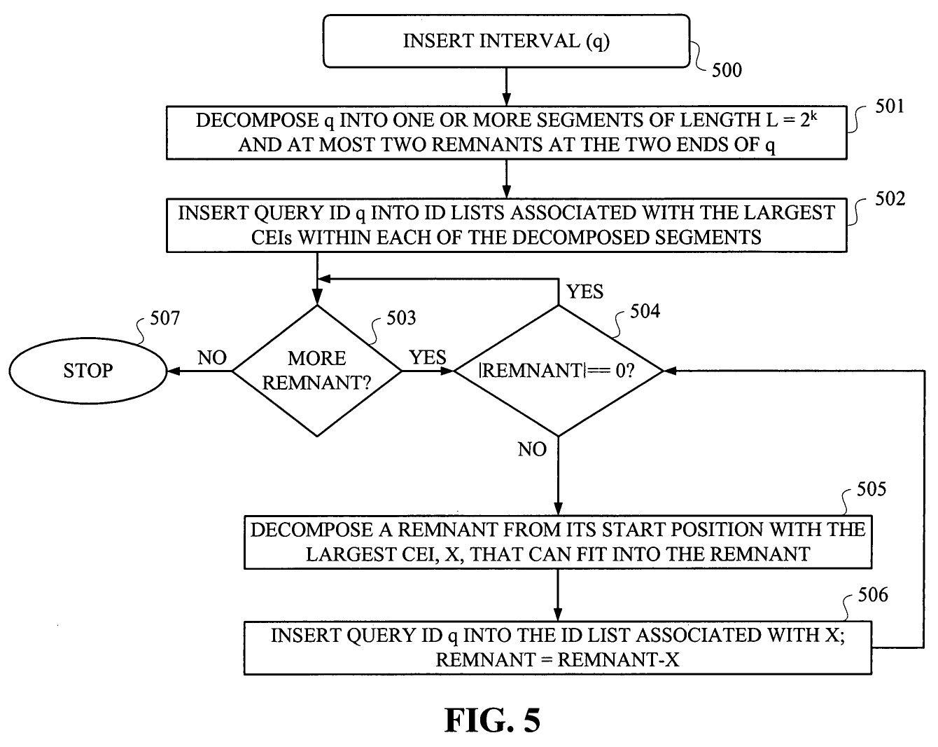

Interval query index 102 is constructed using a containment-encoded interval indexing method according to the invention. Query composer 106 can be used for users to specify the interval queries. Each interval query can be specified with at least a pair of endpoints, such as two integers. Once specified, the interval query is inserted (to be further described below in the context of FIG. 5) into interval query index 102.

Finally, data stream processing system 101 may also comprise miscellaneous handler 107, which performs other processing tasks on the input data streams. For example, additional meta-data can be attached to the data stream.

One goal of a containment-encoded interval indexing approach of the invention is to help speed up the identification of one or more continual interval queries that match a given data value from the incoming data stream. For example, the following two continual interval queries can be defined to monitor the temperature readings contained in a sensor data stream: “Q1: if (95<=t<=100), send an alert to Jane@us.ibm.com” and “Q2: if (98<=t<=102), send an alert to Robert@us.ibm.com”. If the current reading from the incoming data stream is 94, it does not match with either Q1 or Q2. Hence, no alert is sent. However, if the current reading from the incoming stream is 99, then both Q1 and Q2 are matching the reading. Alerts will be sent to Jane@us.ibm.com and Robert@us.ibm.com.

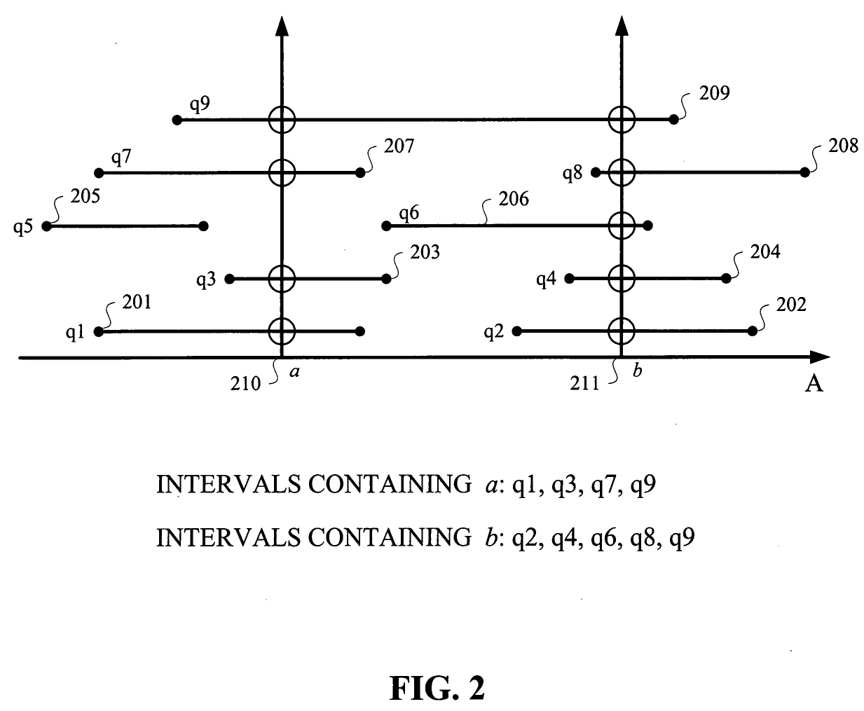

FIG. 2 shows, as an example, the problem of matching a data item against a set of intervals. Assume a query interval is specified as an interval with two endpoints and is represented as a line segment. There are nine interval queries, q1, q2 . . . and q9 (201-209). These interval queries are drawn as horizontal line segments with two endpoints. To find out which interval queries match or contain an incoming data item, a vertical line can be drawn at the data value. The answer includes those interval queries whose line segments intersect with the vertical data line. For example, in FIG. 2, the interval queries that match data value a include q1, q3, q7 and q9. Similarly, interval queries q2, q4, q6, q8 and q9 contain or match data value b.

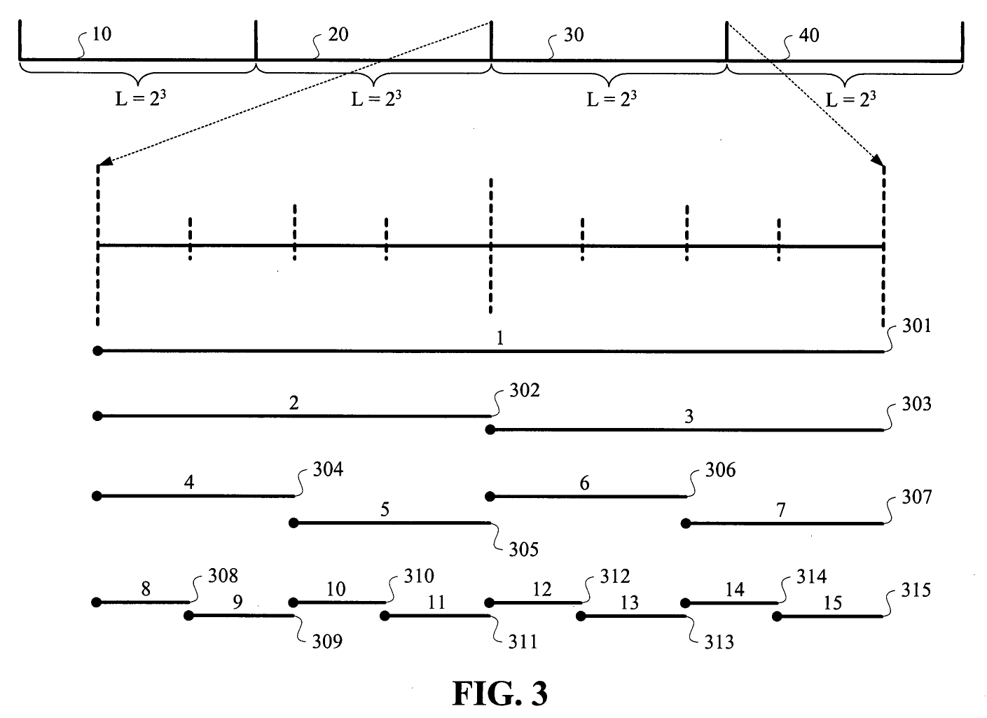

FIG. 3 shows, as an example, a definition of containment-encoded intervals. Assume R is the attribute range specified by all the query intervals. We assume that query intervals are specified with two integers. Data values can be non-integers. For a non-integer interval, one can use the minimal-sized integer interval that contains it to represent it. However, an extra checking is needed at the end of a search operation to ensure that a non-integer query interval does indeed match the data value.

First, R is partitioned into one or more segments of length L=2^{k}. For example, in FIG. 3, there are four segments of length 8 (10, 20, 30 and 40). Within each segment, 2L−1 containment-encoded virtual intervals are defined. FIG. 3 shows an example of containment-encoded virtual intervals and their local ID assignments, where L=8. Virtual interval 1 (301) has length 8; virtual intervals 2 (302) and 3 (303) are defined by dividing virtual interval 1 (301) into half, with the left half as interval 2 (302) and the right half as interval 3 (303). Virtual intervals 4 (304) and 5 (305) are similarly defined by further dividing virtual interval 2 (302) into half, with the left half as interval 4 (304) and the right half as interval 5 (305).

This dividing process continues until intervals 8, 9, 10, 11, 12, 13, 14 and 15 (308-309) are similarly defined. The local IDs of these virtual intervals within a segment are encoded with the containment relationship. Namely, virtual interval m contains virtual interval 2m and 2m+1, where m, 2m and 2m+1 are local IDs within the same segment. However, the global ID of a virtual interval is dependent on the segment ID. Namely, the unique global ID for a virtual interval with a local ID of m within segment S is 2L*S+m.

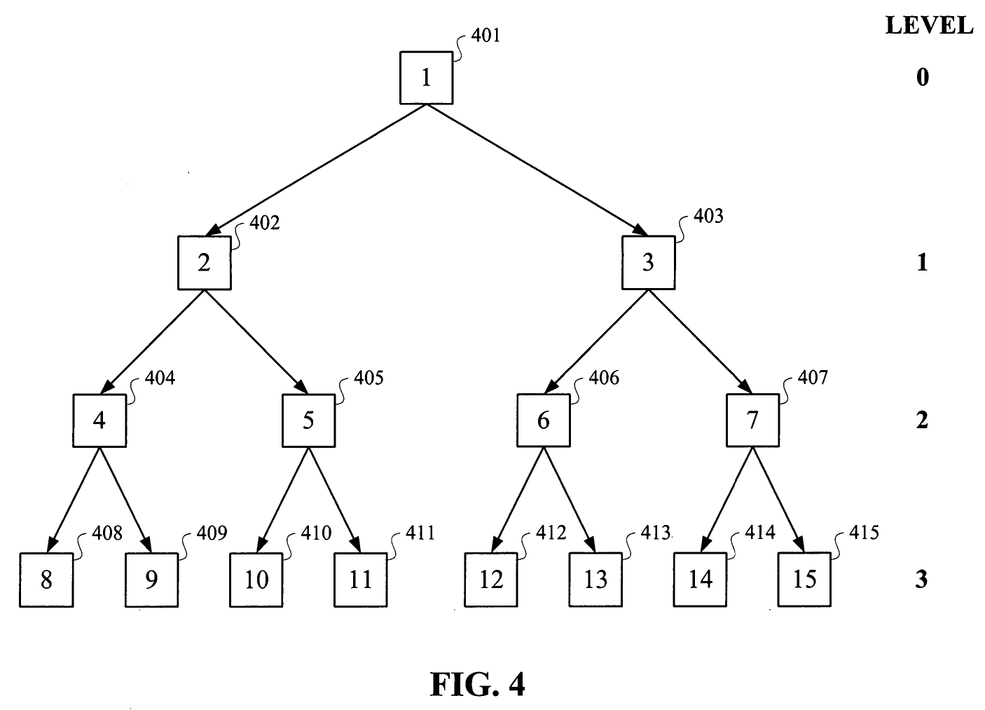

The local ID labeling for CEIs within a segment follows that of a perfect binary tree. FIG. 4 shows an example of a perfect binary tree with a total of 15 nodes. It has four levels. Each non-leaf node has two child nodes. The root node, labeled with ID 1 (401) is at level 0. Node 1 has two child nodes labeled as 2 (402) and 3 (403). These two nodes are at level 1. Nodes 4-7 (404-407) are at level 2. Similarly, nodes 8-15 (408-415) are at level 3 and they are leaf nodes. In a perfect binary tree, the ancestor nodes can be easily computed by repeatedly dividing the ID of a descendant node by 2 (integer division). For example, the ancestor nodes for node 9 can be computed by repeatedly dividing nine by two until it becomes one. Namely, the ancestors of node 9 are nodes 4, 2 and 1. In other words, the two immediate child nodes of a node m are 2m and 2m+1.

A containment-encoded interval (CEI) index is constructed as follows. Each query interval is first decomposed into one or more containment-encoded virtual intervals. Then, the query ID is inserted into the ID lists associated with the decomposed CEIs. FIG. 5 shows a flow diagram of inserting an interval query q (500). Because the length of q can be larger or smaller than the segment size L, interval query q is first decomposed into one or more segments of length L and at most two remnants with length less than L (step 501). The remnants must be at the two ends of q. However, if the length of q is less than L, then the entire query interval is treated as a remnant and it is inside a segment.

Query ID q is then inserted into the ID lists associated with the largest CEIs within each of the decomposed segment (step 502). Note that the largest CEI within a segment has the local ID 1 and it has length L. After that, the remnants are decomposed into one or more CEIs and the query ID q is inserted into the ID lists associated with these decomposed CEIs (steps 503-506). If no more remnants are left, the insertion algorithm stops (step 507).

For each remnant, the decomposition ends when its length is zero (step 504). The decomposition begins from the starting position of the remnant and finds the largest CEI, X, that can fit into the remnant (step 506). Then, the query ID q is inserted into the ID list associated with X. X is removed from the remnant (step 506). After that the decomposition process continues at step 504 to test if the length of the resulting remnant is zero. If not, steps 505 and 506 are repeated.

It is to be appreciated that the insertion algorithm described in FIG. 5 tries to use a minimal number of CEIs in the decomposition of an interval query. There can be more than one possible way for decomposition. However, because the query ID is inserted into the ID lists associated with each decomposed CEIs, the index storage cost can be minimized if a minimal number of CEIs are used in the decomposition.

FIG. 6 shows an algorithm for searching an interval query index built with the method described in FIG. 5. The input parameter for search is a data value y. The search operation starts by computing the segment ID s that contains data value y (step 601). This can be done by using the formula, s=└└y┘/L┘, where └y┘ is a floor operator which returns the largest integer number that is smaller or equal to y. After the segment ID is computed, the local ID m of the unit-length CEI can be computed (step 602). This can be done via the following formula, m=└y┘−sL+L.

With the local ID of the unit-length CEI available, all the other CEIs that can possibly contain data value y are identified (steps 603-607). In step 603, the algorithm checks if m is 0. If yes, then the search process stops (607). If not, then the algorithm computes the global ID c of CEI with local ID m, and outputs all the IDs stored in the ID list associated with CEI c (step 604). Then, the algorithm computes a new m by an integer division of m by two (step 605). With a new m, the algorithm computes the corresponding new c and outputs the IDs stored in the ID list associated with CEI c (step 606). After that the process repeats beginning at step 603.

It is to be appreciated that the query intervals described so far are assumed to be close-ended. However, they can be open-ended, such as A>4. In this case, a query ID can be inserted into R/L CEIs in the worst case, where R is the range of the attribute.

To reduce the index storage cost, one can set L to be as large as R.

It is also to be appreciated that the CEI-based query index is naturally suited for parallel processing. One can control both storage cost and search time by choosing a relatively large L and by properly partitioning R into multiple partitions. One machine can then be used to process a partition.

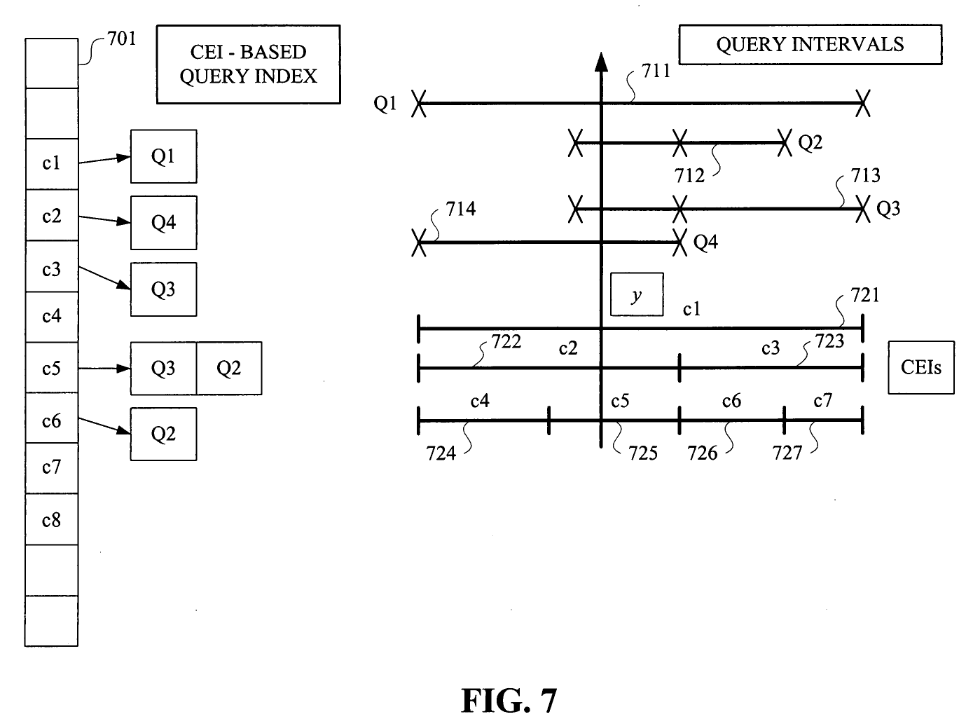

FIG. 7 shows, as an example, the insertion and search operations with a CEI-based query indexing approach according to an embodiment of the invention. Assume a set of eight CEIs (721-727) are predefined within a segment and their IDs are c1-c7. Associated with each CEI is a query ID list (701) storing the IDs of interval queries that use the CEI in their decomposition. For example, interval query Q1 (711) is decomposed into CEI c1. Hence, Q1 is inserted into the ID list associated with c1 (701). Interval query Q2 (712) is decomposed into two CEIs, i.e., c5 and c6. Hence, Q2 is stored in the ID lists associated with c5 and c6 (701). Similarly, interval query Q3 (713) is decomposed into two different CEIs, i.e., c3 and c5. Hence, Q3 is stored in the ID lists associated with c3 and c5. Similarly, Q4 is stored in the ID list associated with c2 because it is decomposed into c2.

For a search operation with a data value y, via a simple computation, the unit-sized CEI, c5, that contains y can be identified. Then, via containment-encoding, all the other CEIs that can possibly contain y can be identified. In this case, these CEIs are c2 and c1 because they both contain c5. The search result is stored in the ID lists associated with all the containing CEIs, c5, c2, and c1. From the CEI-based query index (701), the search result is {Q1, Q2, Q3, Q4}.

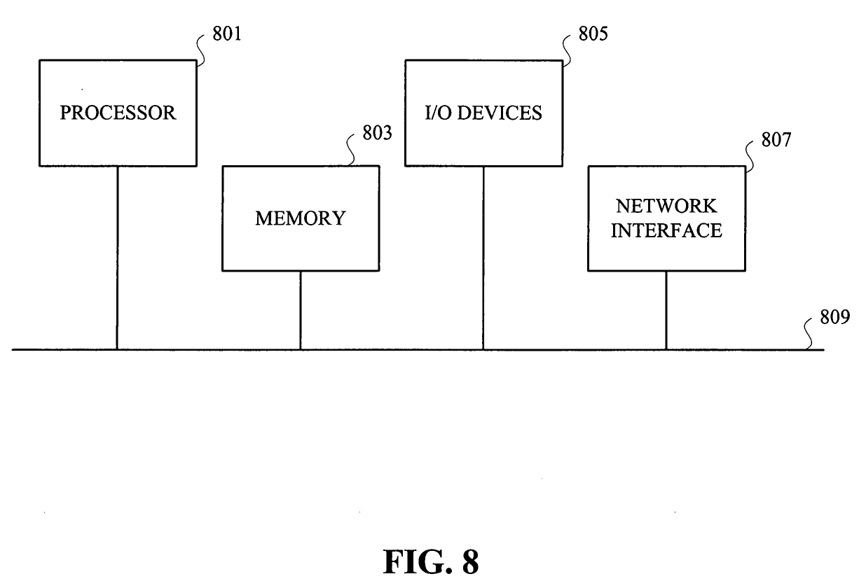

FIG. 8 illustrates an exemplary computing system environment for implementing a data stream processing system according to an embodiment of the present invention. More particularly, the functional blocks illustrated in FIG. 1 may implement such a computing system as shown in FIG. 8 to perform the techniques of the invention (e.g., as described above in the context of FIGS. 2 through 7). For example, a server implementing the data stream processing principles of the invention may implement such a computing system. Of course, it is to be understood that the invention is not limited to any particular computing system implementation.

In this illustrative implementation, a processor 801 for implementing at least a portion of the methodologies of the invention is operatively coupled to a memory 803, input/output (I/O) devices 805 and a network interface 807 via a bus 809, or an alternative connection arrangement. It is to be appreciated that the term “processor” as used herein is intended to include any processing device, such as, for example, one that includes a central processing unit (CPU) and/or other processing circuitry (e.g., digital signal processor (DSP), microprocessor, etc.). Additionally, it is to be understood that the term “processor” may refer to more than one processing device, and that various elements associated with a processing device may be shared by other processing devices.

The term “memory” as used herein is intended to include memory and other computer-readable media associated with a processor or CPU, such as, for example, random access memory (RAM), read only memory (ROM), fixed storage media (e.g., hard drive), removable storage media (e.g., diskette), flash memory, etc.

In addition, the phrase “I/O devices” as used herein is intended to include one or more input devices (e.g., keyboard, mouse, etc.) for inputting data to the processing unit, as well as one or more output devices (e.g., CRT display, etc.) for providing results associated with the processing unit.

Still further, the phrase “network interface” as used herein is intended to include, for example, one or more devices capable of allowing the computing system 600 to communicate with other computing systems. Thus, the network interface may include a transceiver configured to communicate with a transceiver of another computing system via a suitable communications protocol, over a suitable network, e.g., the Internet, private network, etc. It is to be understood that the invention is not limited to any particular communications protocol or network.

It is to be appreciated that while the present invention has been described herein in the context of a data processing system, the methodologies of the present invention may be capable of being distributed in the form of computer readable media, and that the present invention may be implemented, and its advantages realized, regardless of the particular type of signal-bearing media actually used for distribution. The term “computer readable media” as used herein is intended to include recordable-type media, such as, for example, a floppy disk, a hard disk drive, RAM, compact disk (CD) ROM, etc., and transmission-type media, such as digital and analog communication links, wired or wireless communication links using transmission forms, such as, for example, radio frequency and optical transmissions, etc. The computer readable media may take the form of coded formats that are decoded for use in a particular data processing system.

Accordingly, one or more computer programs, or software components thereof, including instructions or code for performing the methodologies of the invention, as described herein, may be stored in one or more of the associated storage media (e.g., ROM, fixed or removable storage) and, when ready to be utilized, loaded in whole or in part (e.g., into RAM) and executed by the processor 801.

In any case, it is to be appreciated that the techniques of the invention, described herein and shown in the appended figures, may be implemented in various forms of hardware, software, or combinations thereof, e.g., one or more operatively programmed general purpose digital computers with associated memory, application-specific integrated circuit(s), functional circuitry, etc. Given the techniques of the invention provided herein, one of ordinary skill in the art will be able to contemplate other implementations of the techniques of the invention.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method for use in processing a data stream, comprising the steps of:
partitioning an attribute range of query intervals associated with the data stream into one or more segments;
defining a set of virtual intervals for each of the one or more segments; and
building a query interval index using the set of virtual intervals.

2. The method of claim 1, wherein the step of building of the query interval index further comprises the steps of:
decomposing each query interval into one or more of the virtual intervals; and
associating a query identifier with the decomposed virtual intervals.

3. The method of claim 1, wherein the step of defining a set of virtual intervals for each of the one or more segments further comprises the steps of:
defining a virtual interval which covers the segment and labeling the virtual interval with a first local identifier;
partitioning the segment into two equal-length virtual intervals and respectively labeling the two equal-length virtual intervals from left to right with second and third local identifiers;
partitioning the segment into four equal-length virtual intervals and respectively labeling the four equal-length virtual intervals from left to right with fourth, fifth, sixth and seventh local identifiers; and
continuing the partitioning step until each virtual interval has a length of one.

4. The method of claim 1, further comprising the step of searching the query interval index with a data value.

5. The method of claim 4, wherein the searching step further comprises the steps of:
finding the smallest-sized virtual interval containing the data value;
finding other virtual intervals containing the smallest-sized virtual interval; and
obtaining query identifiers associated with the found virtual intervals.

6. The method of claim 5, wherein the searching step further comprises the virtual intervals for each segment comprising a set of containment-encoded intervals (CEI), each CEI having a local identifier (ID) and a global ID.

7. The method of claim 6, wherein the searching step further comprises a CEI with a local ID of m containing two half-sized CEIs with local IDs of 2m and 2m+1.

8. The method of claim 7, wherein the step of finding other virtual intervals containing the smallest-sized virtual interval further comprises the steps of:
finding the global ID and local ID of the smallest-sized CEI; and
repeatedly dividing the local ID by two to find the local ID of other CEIs that contain the smallest-sized CEI.

9. Apparatus for use in processing a data stream, comprising:
a memory; and
at least one processor coupled to the memory and operative to: (i) partition an attribute range of query intervals associated with the data stream into one or more segments; (ii) define a set of virtual intervals for each of the one or more segments; and (iii) build a query interval index using the set of virtual intervals.

10. The apparatus of claim 9, wherein the operation of building of the query interval index further comprises decomposing each query interval into one or more of the virtual intervals, and associating a query identifier with the decomposed virtual intervals.

11. The apparatus of claim 9, wherein the operation of defining a set of virtual intervals for each of the one or more segments further comprises defining a virtual interval which covers the segment and labeling the virtual interval with a first local identifier, partitioning the segment into two equal-length virtual intervals and respectively labeling the two equal-length virtual intervals from left to right with second and third local identifiers, partitioning the segment into four equal-length virtual intervals and respectively labeling the four equal-length virtual intervals from left to right with fourth, fifth, sixth and seventh local identifiers, and continuing the partitioning step until each virtual interval has a length of one.

12. The apparatus of claim 9, wherein the at least one processor is further operative to search the query interval index with a data value.

13. The apparatus of claim 12, wherein the searching operation further comprises finding the smallest-sized virtual interval containing the data value, finding other virtual intervals containing the smallest-sized virtual interval, and obtaining query identifiers associated with the found virtual intervals.

14. The apparatus of claim 13, wherein the searching operation further comprises the virtual intervals for each segment comprising a set of containment-encoded intervals (CEI), each CEI having a local identifier (ID) and a global ID.

15. The apparatus of claim 14, wherein the searching operation further comprises a CEI with a local ID of m containing two half-sized CEIs with local IDs of 2m and 2m+1.

16. The apparatus of claim 15, wherein the operation of finding other virtual intervals containing the smallest-sized virtual interval further comprises finding the global ID and local ID of the smallest-sized CEI, and repeatedly dividing the local ID by two to find the local ID of other CEIs that contain the smallest-sized CEI.

17. Apparatus for use in processing a data stream, comprising:
a server operative to: (i) partition an attribute range of query intervals associated with the data stream into one or more segments; (ii) define a set of virtual intervals for each of the one or more segments; and (iii) build a query interval index using the set of virtual intervals.

18. An article of manufacture for use in processing a data stream, comprising a machine readable medium containing one or more programs which when executed implement the steps of:
partitioning an attribute range of query intervals associated with the data stream into one or more segments;
defining a set of virtual intervals for each of the one or more segments; and
building a query interval index using the set of virtual intervals.
